(19) United States
(12) Patent Application Publication
(10) Pub. No.: US 2011/0310157 A1
(43) Pub. Date: Dec. 22, 2011

(54) INKJET IMAGE FORMING APPARATUS AND INKJET IMAGE FORMING METHOD

(75) Inventors: Kazuhiko Ohtsu, Shizuoka-ken (JP); Masashi Hiroki, Kanagawa-ken (JP); Atsushi Kubota, Shizuoka-ken (JP); Satoshi Kaiho, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/161,655

(22) Filed: Jun. 16, 2011

Related U.S. Application Data
(60) Provisional application No. 61/355,826, filed on Jun. 17, 2010.

(51) Int. Cl. B41J 29/38

(52) U.S. Cl. 347/16

(57) ABSTRACT

According to one embodiment, an inkjet image forming apparatus includes a transport section configured to adsorb a recording medium by suction to transport the recording medium under inkjet heads, and a controller configured to perform control in a manner that an adsorption force to the recording medium if the image is formed on a second surface of the recording medium is larger than an adsorption force to the recording medium if the image is formed on a first surface of the recording medium.

### CROSS-REFERENCE TO RELATED APPLICATIONS

This application is based upon and claims the benefit of U.S. Provisional Application No. 61/355,826, filed on Jun. 17, 2010; the entire contents of which are incorporated herein by reference.

### FIELD

Embodiments described herein relate generally to an inkjet image forming apparatus which ejects aqueous ink from inkjet heads to form an image on a recording medium, and an inkjet image forming method thereof.

### BACKGROUND

Conventionally, when printing is performed with aqueous ink on a recording medium such as a recording paper using an inkjet image forming apparatus, it is not easy to avoid cockling or curling of the recording paper due to swelling of paper fibers due to moisture in the ink. When double-sided printing is performed on the recording medium on which the cockling or curling occurs, there is a problem of image quality deterioration.

When double-sided printing is performed using the inkjet image forming apparatus, a front surface is firstly printed, the front and rear surfaces of the recording paper are reversed, and then, the rear surface is printed. A time difference occurs up until the rear surface of the recording paper is printed after the front surface of the recording paper is printed by the aqueous inkjet ink. Cockling or curling occurs in the recording paper even during a small time difference. Since a height difference occurs on the front surface of the recording paper on which cockling or curling occurs, there is a problem that deterioration of image quality occurs by image blurring or color misalignment due to landing position misalignment in the inkjet printing or the like when the rear surface of the recording paper is printed.

### BRIEF DESCRIPTION OF THE DRAWINGS

FIG. 1 is an exemplary diagram schematically illustrating a configuration of an inkjet image forming apparatus according to an embodiment.

FIG. 2 is an exemplary diagram illustrating a surface, being in contact with a transport belt, of a top plate according to the present embodiment.

FIG. 3 is an exemplary diagram illustrating a transport belt according to the present embodiment.

FIG. 4 is an exemplary diagram illustrating small through holes formed in the transport belt according to the present embodiment.

FIG. 5 is an exemplary block diagram illustrating a configuration of a control system of the inkjet image forming apparatus according to the present embodiment.

FIG. 6 is an exemplary flowchart illustrating an image forming operation of the inkjet image forming apparatus according to the present embodiment.

FIG. 7 is an exemplary diagram illustrating the relationship between an adsorption force and a deformation amount (maximum value) due to cockling in the inkjet image forming apparatus according to the present embodiment.

FIG. 8 is an exemplary diagram schematically illustrating a configuration of an inkjet image forming apparatus according to a second embodiment.

FIG. 9 is an exemplary block diagram illustrating a configuration of a control system of the inkjet image forming apparatus according to the second embodiment.

### DETAILED DESCRIPTION

In general, according to one embodiment, there is provided an inkjet image forming apparatus configured to eject aqueous ink using inkjet heads to form an image on a front surface and a rear surface of a recording medium. The apparatus includes: a transport section configured to adsorb the recording medium by suction to transport the recording medium under the inkjet heads; and a controller configured to perform control in a manner that an adsorption force to the recording medium if the image is formed on a second surface (rear surface) of the recording medium is larger than an adsorption force to the recording medium if the image is formed on a first surface (front surface on which the image is initially formed) of the recording medium.

### First Embodiment

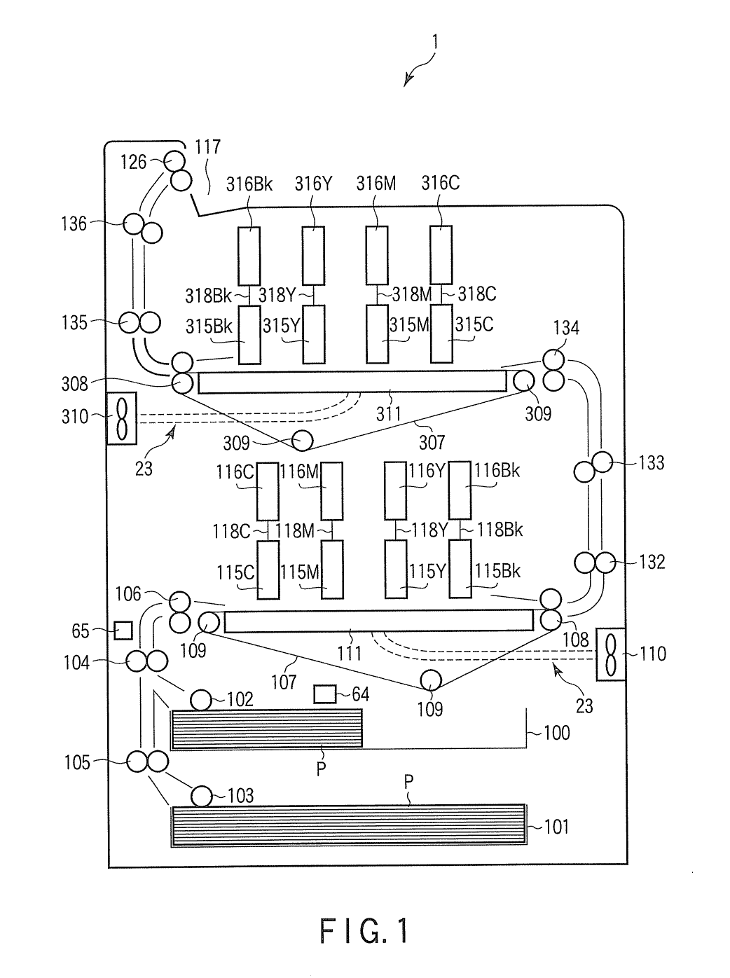

FIG. 1 is an exemplary diagram schematically illustrating a configuration of an inkjet image forming apparatus 1 according to an embodiment.

Paper cassettes 100 and 101 contain recording paper p having different sizes. A paper supply roller 102 or 103 extracts the recording paper p corresponding to a selected paper size from the paper cassette 100 or 101, and transports the extracted paper to a transport roller pair 104 or 105 and a resist roller pair 106. Here, the recording paper p is not specialist paper but plain paper.

A transport belt 107 is given tension by a driving roller 108 and two driven rollers 109. A plurality of small through holes is formed at a predetermined interval on a front surface of the transport belt 107. The transport belt 107 is an endless belt made by stacking rubber on fabric and polishing a front surface thereof.

A top plate of a negative pressure chamber 111 is installed to be in close contact with a rear surface of the transport belt 107 which is a surface being in contact with the driving roller 108. The negative pressure chamber 111 is connected to a fan 110 through a duct 23. The negative pressure chamber 111 is a box housing having the top plate in which a plurality of grooves and holes are formed and an opening formed for connection with the duct 23 for air discharge. The inside of the hollow housing is set to a negative pressure by suction of the fan 110.

The recording paper p is adsorbed onto a transport surface of the transport belt 107 through the plurality of small through holes on the duct 23, the negative pressure chamber 111 and the transport belt 107, using a suction force generated by the suction fan 110. Then, the recording paper p is transported while being adsorbed onto the transport belt 107.

Four rows of linear inkjet heads 115 which eject ink on the recording paper according to image data are aligned above the transport belt 107 (a first inkjet head unit). An inkjet head 115C which ejects cyan (C) ink, an inkjet head 115M which ejects magenta (M) ink, an inkjet head 115Y which ejects yellow (Y) ink and an inkjet head 115Bk which ejects black (Bk) ink are sequentially provided from the upstream side (left side in the figure). Further, a cyan (C) ink cartridge 116C, a magenta (M) ink cartridge 116M, a yellow (Y) ink cartridge 116Y, and a black (Bk) ink cartridge 116Bk which contain respective color inks are provided in the respective inkjet heads 115. Further, the inkjet heads 115 and the ink cartridge 116 are respectively connected by tubes 118. An image forming section including these components is arranged as an image forming section exclusively used for front surface printing of the recording paper p.

Further, the inkjet image forming apparatus 1 includes a temperature and moisture detecting sensor 64, and a paper thickness detecting sensor 65. The temperature and moisture detecting sensor 64 detects the temperature and moisture inside the paper cassettes 100 and 101. The paper thickness detecting sensor 65 detects the recording paper p extracted from the paper cassette 100 or 101 for image forming.

Above each inkjet head 115 and each ink cartridge 116, that is, on a downstream side from each inkjet head with respect to a transport direction, an image forming section exclusively used for rear surface recording of the recording paper p is disposed. The image forming section exclusively used for rear surface recording has the same configuration as the image forming section exclusively used for front surface recording of the recording paper p. Transport roller pairs 132 and 133 and a resist roller pair 134 which transport the recording paper p to the image forming section exclusively used for rear surface recording are provided. The transport roller pairs 132 and 133 and the resist roller pair 134 form a part of a reverse mechanism, in which the reverse mechanism is formed in a U shape.

A transport belt 307 is given tension by a driving roller 308 and two driven rollers 309. A plurality of small through holes is formed at a predetermined interval on a front surface of the transport roller 307. A top plate of a negative pressure chamber 311 connected to a fan 310 through a duct 23 is installed, inside the transport belt 307, so as to be in close contact with a rear surface of the transport belt 307, in order to allow the recording paper p to be adsorbed onto the transport belt 307.

Four rows of inkjet heads exclusively used for rear surface printing which eject ink on the recording paper according to image data are aligned above the transport belt 307 (a second inkjet head unit). Since the inkjet heads 115 and the ink cartridges 116 disposed in the lower image forming section have the same configuration as in the inkjet heads 315 and the ink cartridges 316 except different reference numerals, their description will be omitted.

Further, transport roller pairs 135 and 136 and a paper discharge roller pair 126 are installed on a paper discharge side. In the case of face-down paper discharge in double-sided recording, the rear surface becomes a first page surface, and the front surface becomes a second page surface. In the case of face-up paper discharge, the front surface becomes the first page surface, and the rear surface becomes the second page surface.

The respective color inks include black (Bk), yellow (Y), cyan (C) and magenta (M), and use aqueous ink including solid content or additive agents and other compositions having moisture content of about 30 to 80 percent by weight.

A specific configuration of the medium transport section will be described in detail with reference to the lower image forming section. Since the upper image forming section has the same configuration, its description will be omitted.

The medium transport section includes a transport section which has a function of transporting the recording paper p and a movement section which allows the transport section to be in contact with or separated from the inkjet heads 115. Description regarding a specific configuration of the movement section for the contact and separation will be omitted herein.

The transport section includes the transport belt 107, the driving roller 108, the driven rollers 109, the negative pressure chamber 111, and the duct 23.

The transport belt 107 transports the recording paper p. The driving roller 108 and the driven roller 109 corresponding thereto drive the transport belt 107. The negative pressure chamber 111 and the duct 23 allow the recording paper p to be adsorbed onto the transport belt 107. The driving roller 108 is driven by a driving section (not shown). The transport section including these components is integrally accommodated in a casing.

The negative pressure chamber 111 includes the top plate 23a and the box housing. The negative pressure chamber 111 is set to a negative pressure therein and is disposed so that a front surface of the top plate 23a is in contact with the rear surface of the transport belt 107.

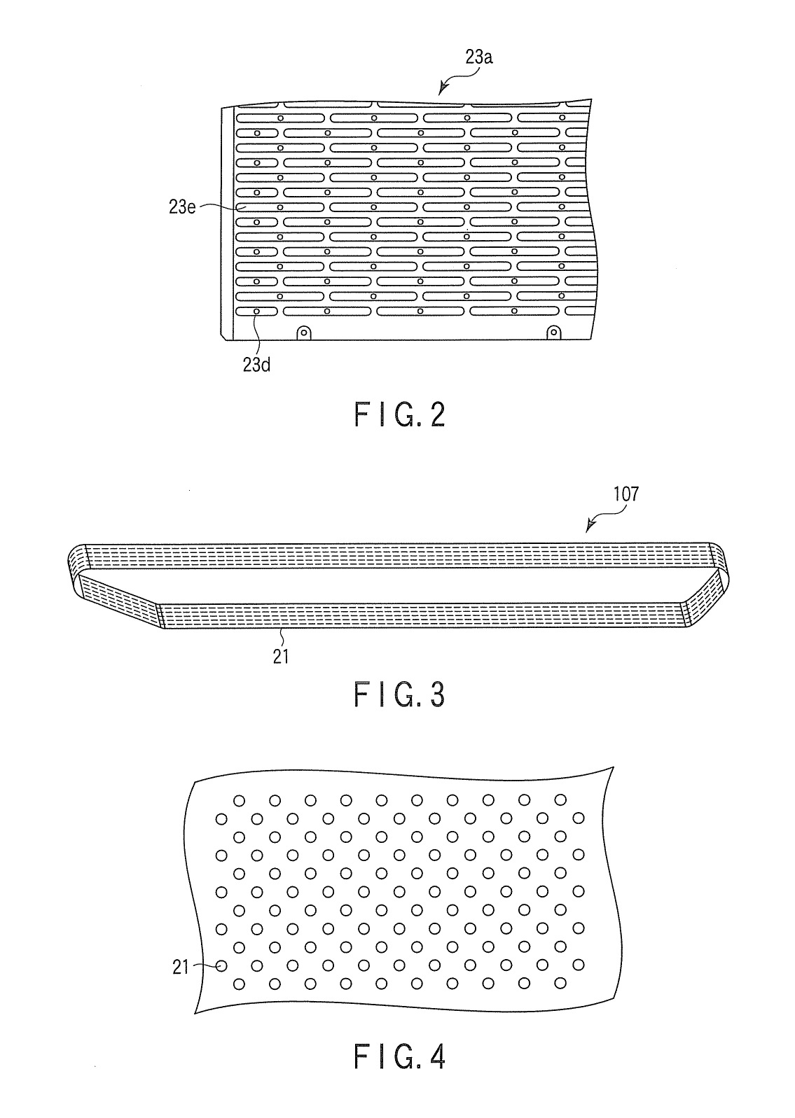

FIG. 2 is an exemplary diagram illustrating a surface, being in contact with the transport belt 107, of the top plate 23a according to the present embodiment.

FIG. 3 is an exemplary diagram illustrating the transport belt 107 according to the present embodiment, and FIG. 4 is an exemplary diagram illustrating small through holes formed in the transport belt according to the present embodiment.

The plurality of grooves 23e is formed in the top plate 23a, and a hole 23d is formed in each groove 23e. The transport belt 107 is an endless belt made by stacking rubber on fabric and polishing a surface thereof, and the small through holes 21 are formed on the entire surface thereof. Alternatively, the transport belt 107 may be integrally formed of resin such as a polyimide, or may be obtained by performing an end process for an end belt formed of stainless steel or the like.

The suction force generated by the suction fan 110 allows the recording paper p to be adsorbed onto the transport surface of the transport belt 107 through the duct 23, the top plate 23a and the small through holes 21 on the transport belt 107. The recording paper p is transported at a desired speed with the operation of the transport belt 107.

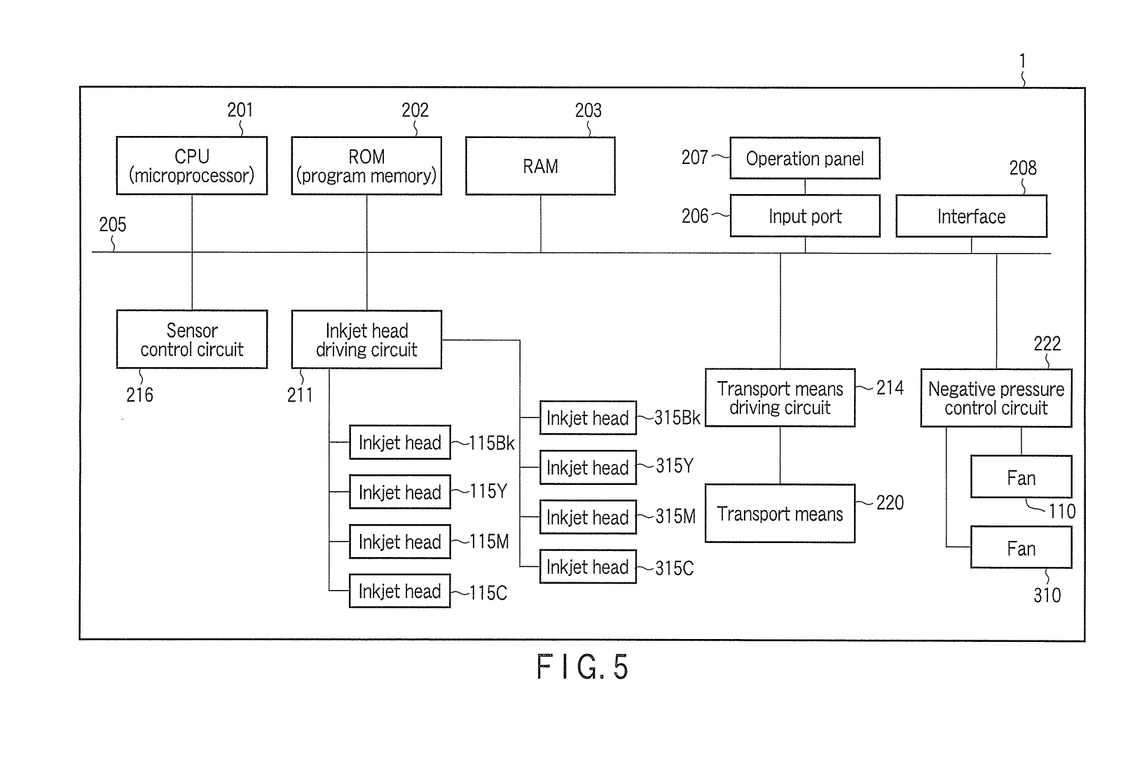

FIG. 5 is an exemplary block diagram illustrating a configuration of a control system of the inkjet image forming apparatus 1 according to the present embodiment.

The control system of the inkjet image forming apparatus 1 includes a CPU (Central Processing Unit) 201 which is a processor, a ROM (read only memory) 202, a RAM (Random Access Memory) 203, a CPU bus 205, an input port 206, an interface 208, an inkjet head driving circuit 211, a transport means driving circuit 214, a sensor control circuit 216, a negative pressure control circuit 222, and the like. The processor is also a controller.

The CPU 201 generally controls the respective components of the inkjet image forming apparatus 1. The ROM 202 and the RAM 203 is connected with the CPU 201 through the CPU bus 205 to form a microcomputer. The ROM 202 stores an operation program which executes a driving control. The RAM 203 stores data. The input port 206 communicates information with an operation panel 207. The interface 208 communicates information with an external computer.

The inkjet head driving circuit 211 drives and operates the respective inkjet heads 115 and 315. The transport means driving circuit 214 controls the transport means 220 including the transport roller pairs 104 and 105, the driving roller 108 and the like. The negative pressure control circuit 222 controls operation voltages of the fans 110 and 310. The sensor control circuit 216 outputs signals from the temperature and moisture detecting sensor 64 and the paper thickness detecting sensor 65 to the CPU 201.

Next, an operation of the control system will be described. The respective components of the inkjet image forming apparatus 1 are basically controlled by the CPU 201. The respective components are controlled according to the operation program stored in the ROM 202.

Firstly, image data or a printing command transmitted from the external computer through the interface 208 is transmitted to the RAM 203, and is processed by the CPU 201 on the basis of the operation program stored in the ROM 202, stored instruction data, or the like. The processed printing data is transmitted to the inkjet head driving circuit 211, and a driving signal for printing is transmitted to each inkjet head 115.

On the other hand, the CPU 201 receives information regarding a double-sided recording mode or a one-sided recording mode through the interface 208. Then, the CPU 201 selects image data stored in the data memory 203, and outputs the information to the inkjet head driving circuit 211.

The inkjet head driving circuit 211 is operated according to image data or the like, ink discharge from the inkjet heads 115 is controlled according to a transport timing of the recording paper p. Each inkjet recording head 115 ejects ink onto the recording paper p as multi-drop ink droplets from a nozzle according to the driving signal.

At this time, the driving signals for the respective components which are simultaneously processed by the CPU 201 are transmitted to the inkjet head driving circuit 211, the transport means driving circuit 214, and the negative pressure control circuit 222. Then, each component of the inkjet image forming apparatus 1 is controlled by an operation process according to the operation program to be driven, so that an image can be recorded on the recording paper p. Similarly, in the case of double-sided printing, the inkjet recording heads 115 and 315, the transport means 220, and the fans 110 and 310 are controlled by the operation process according to the operation program at predetermined operation timings. At this time, the operation voltages of the fans 110 and 310 are controlled to have a predetermined suction force.

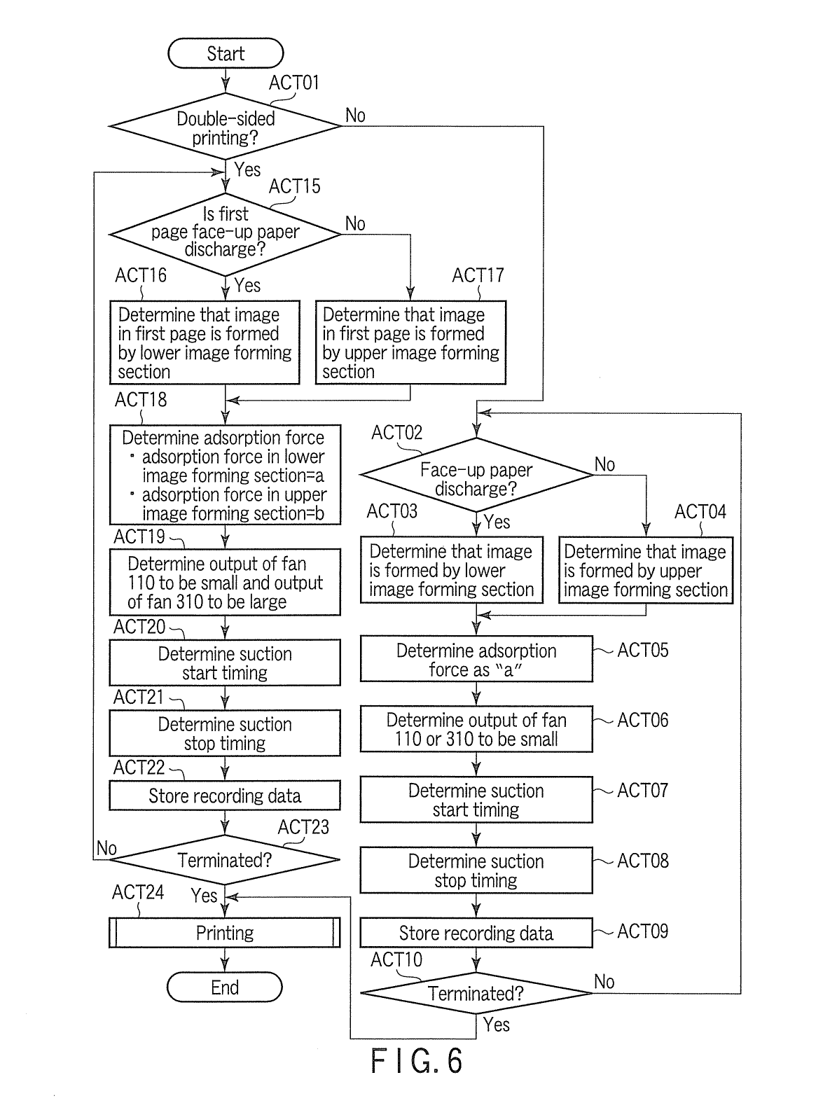

FIG. 6 is an exemplary flowchart illustrating an image forming operation of the inkjet image forming apparatus 1 according to the present embodiment. The image forming operation is started when printing instruction and image data are received from the external computer.

In ACT 01, the CPU 201 determines whether double-sided printing or one-sided printing is performed on the basis of the information received from the interface 208.

In the case of one-sided printing (No in ACT 01), in ACT 02, the CPU 201 determines whether the discharge is the face-up paper discharge. In the case of face-up paper discharge, the front surface becomes the first page surface, and the rear page becomes the second page surface. Accordingly, in the case of face-up paper discharge (Yes in ACT 02), the CPU 201 determines that the image is formed in the lower image forming section of the inkjet image forming apparatus 1, in ACT 03. In a case where the discharge is not face-up paper discharge (No in ACT 02), the CPU 201 determines that the image is formed in the upper image forming section of the inkjet image forming apparatus 1, in ACT 04.

In ACT 05, the CPU 201 determines the adsorption force between the recording paper p and the transport belt 107. This case corresponds to one-sided printing and cockling or the like is not generated on the recording paper p. Thus, the CPU 201 determines the adsorption force as “a” on the basis of the thickness of the recording paper p and the temperature and moisture. The thickness of the recording paper p and the temperature and moisture may be used as a setting value from the operation panel 207 or may be used as a value detected by the temperature and moisture detecting sensor 64 and the paper thickness detecting sensor 65 in the printing operation. In ACT 06, the CPU 201 determines the suction force (rotational rate) of the fan 110 or 310 from the adsorption force “a”. That is, the driving voltage, which generates the adsorption force “a”, of the fan 110 or 310 is determined.

In ACT 07, the CPU 201 determines the timing when the fan 110 or 310 starts suction. For example, in the case of face-up paper discharge, it is determined that the suction is started when a leading edge of the recording paper p reaches the resist roller pair 106. In a case where the discharge is not face-up paper discharge, it is determined that the suction is started when the leading edge of the recording paper p reaches the resist roller pair 134. In ACT 08, the CPU 201 determines the timing when the fan 110 or 310 stops the suction. For example, in the case of face-up paper discharge, it is determined that the suction is stopped when a trailing edge of the recording paper p reaches the transport roller pair 132. In a case where the discharge is not face-up paper discharge, it is determined that the suction is stopped when the trailing edge of the recording paper p reaches the transport roller pair 135.

In ACT 09, the CPU 201 stores the received image data in RAM 203. In ACT 10, the CPU 201 checks whether the printing information is all processed. If the printing information to be processed remains (No in ACT 10), the operations from ACT 02 are performed. If all the printing information is processed (Yes in ACT 10), the printing (image forming) is performed in either the first inkjet head unit 115 or the second inkjet head unit 315, in ACT 24.

When performing double-sided printing (Yes in ACT 01), the CPU 201 determines whether a target page is face-up paper discharge, in ACT 15. In the case of face-up paper discharge, the front surface becomes the first page surface and the rear surface becomes the second page surface. Accordingly, in the case of face-up paper discharge (Yes in ACT 15), the CPU 201 determines that the image in the first page is formed by the lower image forming section of the inkjet image forming apparatus 1, in ACT 16. In a case where the discharge is not face-up paper discharge (No in ACT 15), the CPU 201 determines that the image in the first page is formed by the upper image forming section of the inkjet image forming apparatus 1, in ACT 17.

In ACT 18, the CPU 201 determines the adsorption force between the recording paper p and the transport belt 107. When the image is formed by the lower image forming section, this corresponds to front surface printing, and cockling or the like does not occur on the recording paper p. Thus, the CPU 201 determines the adsorption force as “a” on the basis of the thickness of the recording paper p and the temperature and moisture, for example. In a case where the image is formed by the upper image forming section, this corresponds to the rear surface printing, and cockling or the like occurs on the recording paper p. Thus, the CPU 201 determines the adsorption force as “b” on the basis of the printing rate of the front surface, in addition to the thickness of the recording paper p and the temperature and moisture, for example. The printing rate is defined as a printing area per a unit area of the recording paper p. Here, the adsorption force “b” is determined to be larger than the adsorption force “a” (b>a). Details of the adsorption force will be described later.

In ACT 19, the CPU 201 determines the suction force (rotational rate) of the fan 110 from the adsorption force “a”, and determines the suction force (rotational rate) of the fan 310 from the adsorption force “b”. That is, the driving voltages by which the fans 110 and 310 generate the adsorption forces “a” and “b” is determined.

In ACT 20, the CPU 201 determines the timings for when the fans 110 and 310 start the suction. In ACT 21, the CPU 201 determines the timings for when the fans 110 and 310 stop the suction.

For example, the CPU determines that the fan 110 starts the suction when the leading edge of the recording paper p reaches the resist roller pair 106 and stops the suction when the trailing edge of the recording paper p reaches the transport roller pair 132. The CPU determines that the fan 310 starts the suction when the leading edge of the recording paper p reaches the resist roller pair 134 and stops the suction when the trailing edge of the recording paper p reaches the transport roller pair 135.

In ACT 22, the CPU 201 stores the received double-sided image data in the RAM 203. In ACT 23, the CPU 201 checks whether the printing information is all processed. If the printing information to be processed remains (No in ACT 23), the operations from ACT 15 are performed. If all the printing information is processed (Yes in ACT 23), the printing (image forming) is performed in the first inkjet head unit 115 and the second inkjet head unit 315, in ACT 24.

Next, an image forming operation in the double-sided printing mode of the inkjet image forming apparatus 1 will be described with reference to FIG. 1.

Firstly, image data for front surface printing recording is transmitted to the respective inkjet heads 115C, 115M, 115Y and 115Bk. Further, the recording paper p of a selected paper size is extracted by the paper supply roller 102 or 103 sheet by sheet from the paper cassette 100 or 101, and is transported to the transport roller pairs 104 and 105 and the resist roller pair 106.

The resist roller pair 106 corrects skew of the recording paper p and transports the recording paper p at a predetermined timing. Since the negative pressure chamber 111 draws in air by the fan 110 with a suction amount A through the plurality of small through holes 21 of the transport belt 107, the recording paper p is transported under the inkjet recording heads 115 in a state of being adsorbed to the transport belt 107. Consequently, the inkjet recording heads 115 and the recording paper p can maintain a specific interval.

As each color ink is ejected from each of the inkjet recording heads 115C, 115M, 115Y and 115Bk in synchronization with the timing when the recording paper p is transported from the resist roller pair 106, a color image is formed in a desired position of the front surface of the recording paper p. The recording paper p on the front surface of which the image is formed is transported to the image forming section exclusively used for rear surface printing through the transport roller pairs 132 and 133 and the resist roller pair 134.

The resist roller pair 134 again corrects skew of the recording paper p and transports the recording paper p to the image forming section exclusively used for rear surface printing at a predetermined timing. Since the negative pressure chamber 311 draws in air by the fan 310 with a suction amount B through the plurality of small through holes 21 of the transport belt 307, the recording paper p is transported under the inkjet recording heads 315 in a state of being adsorbed onto the transport belt 307.

The suction amount B is set to be stronger than the suction amount A (suction amount A<suction amount B). Specifically, it is preferable that the adsorption force “a” required for making the recording paper p be set with the suction amount A in close contact with the transport belt 307 be 0.16 gf/cm² or higher for the unit area of the recording paper p, and the adsorption force “b” required for making the recording paper p be set with the suction amount B in close contact with the transport belt 307 be 0.8 gf/cm² or higher for the unit area of the recording paper p.

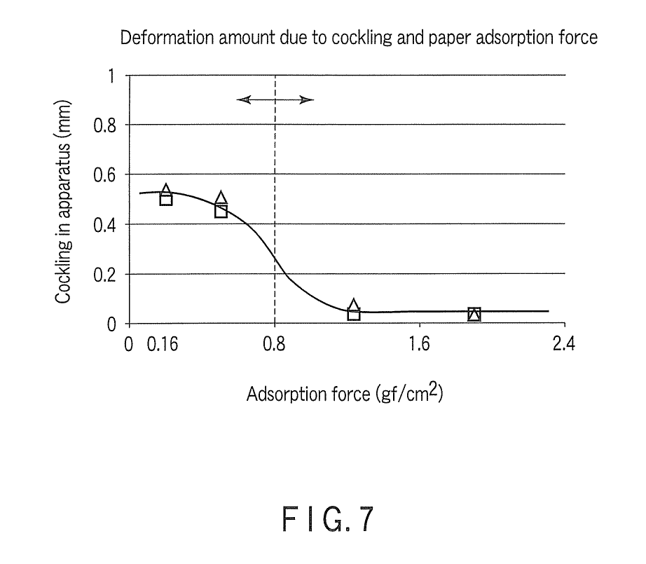

FIG. 7 is an exemplary diagram illustrating the relationship between an adsorption force and a deformation amount (maximum value) due to cockling in the inkjet image forming apparatus 1 according to the present embodiment.

In FIG. 7, cockling of about 0.5 mm occurs on the recording paper p in which the front surface thereof is printed. The deformation amount due to cockling is not observed in the adsorption force “a” (=0.16 gf/cm²). However, if the adsorption force is increased to 0.8 gf/cm², the deformation amount due to cockling is reduced to about 0.3 mm or lower which is an allowable value. Further, if the adsorption force is increased to 1.3 gf/cm², the deformation amount due to cockling is reduced to about 0.05 mm.

As the relationship between the adsorption force and the deformation amount due to cockling as shown in FIG. 7 is calculated in advance according to the thickness of the recording paper p, the temperature and moisture, and a plurality of levels of printing rates in the front surface, it is possible to obtain an appropriate adsorption force. Further, the CPU 201 controls an output of the fan on the basis of the obtained adsorption force. At this time, the rotational rate of the fan may be controlled by controlling electric current while maintaining voltage constantly. Further, the adsorption force may be controlled by configuring the fans 110 and 310 by a plurality of fans and changing the number of the fans.

Under the above-described control, paper cockling or curling generated on the recording paper p in which the front surface thereof is printed is corrected by the adsorption force to the transport belt 307. Accordingly, the inkjet recording heads 315 and the recording paper p can precisely maintain a specific interval. As each color ink is ejected from each of the inkjet heads 315C, 315M, 315Y and 315Bk in synchronization with the timing when the recording paper p is transported from the resist roller pair 134, a color image is formed in a predetermined position of the rear surface of the recording paper p. The recording paper p in which the image is formed on both the surfaces thereof is transported by the transport roller pairs 135 and 136, and is discharged to a paper discharge tray 117 by the paper discharge roller pair 126.

Further, when only one-sided printing is performed and the paper discharge is performed in a face-down paper discharge (in a state where the printing surface faces downward), the printing is performed using the upper image forming section. The recording paper p is transported without being printed by the lower image forming section, and the printing is performed on the rear surface of the recording paper p using the upper image forming section. The recording paper p is transported by the transport roller pairs 135 and 136, and is discharged to the paper discharge tray 117 in the face-down paper discharge by the paper discharge roller pair 126.

In order to realize the above-described printing operation, the CPU 201 drives the inkjet head driving circuit 211 according to image data, and controls the ink ejection from the inkjet recording heads 115 and the inkjet heads 315 according to the transport timing of the recording paper p of the transport means driving circuit 214. The transport means driving circuit 214 controls the transport means 220 to relatively move the recording paper p to each inkjet head 115. Further, the negative pressure control circuit 222 controls the air volume of the fan 110 which generates the adsorption force between the transport belt 107 and the recording paper p in the front surface printing and the rear surface printing, and the air volume of the fan 310 which generates the adsorption force between the transport belt 307 and the recording paper p in the front surface printing and the rear surface printing. When performing only one-sided printing, the air volume of the fan 310 is controlled to have the same air volume of the fan 110.

### Second Embodiment

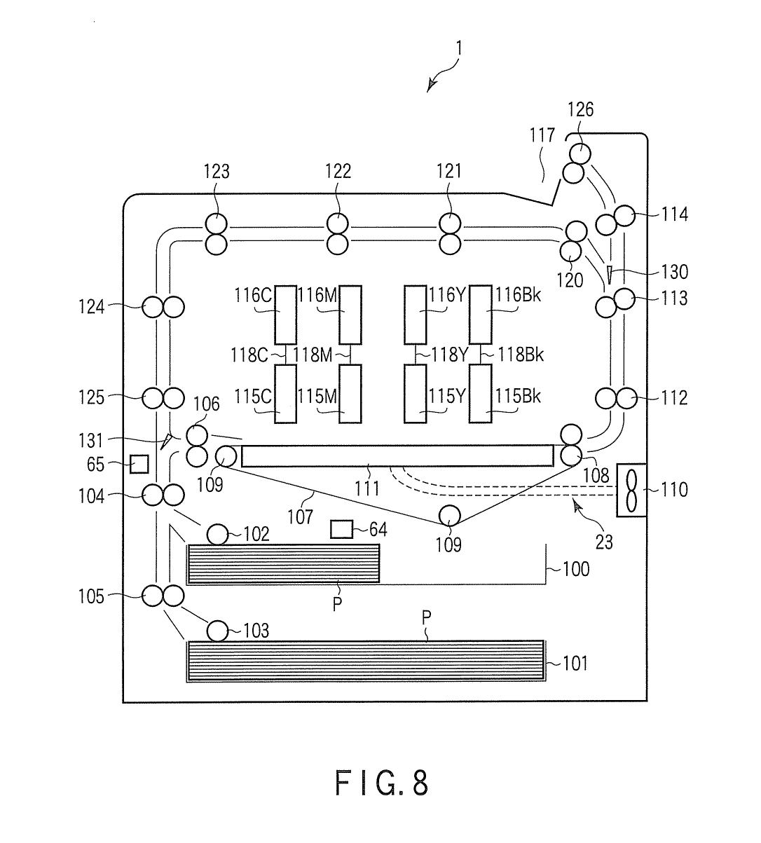

FIG. 8 is an exemplary diagram schematically illustrating a configuration of an inkjet image forming apparatus 1 according to a second embodiment.

The inkjet image forming apparatus 1 according to the second embodiment is different from that of the first embodiment in that the front surface and the rear surface of the recording paper p are printed by one image forming section. The same elements in the second embodiment as those in the first embodiment are given the same reference numerals, and detailed description will be omitted.

As shown in FIG. 8, the transport roller pairs 112, 113 and 114 and the paper discharge roller pair 126 are installed on the paper discharge side of the image forming section. Further, there are installed transport roller pairs 120, 121, 122, 123, 124 and 125 and transport guides 130 and 131 which transport the recording paper p once again to the paper supplying side when double-sided printing is performed. The transport guides 130 and 131 are disposed to switch the transport route of the recording paper p, and the direction of a guide end thereof is changed around a fulcrum.

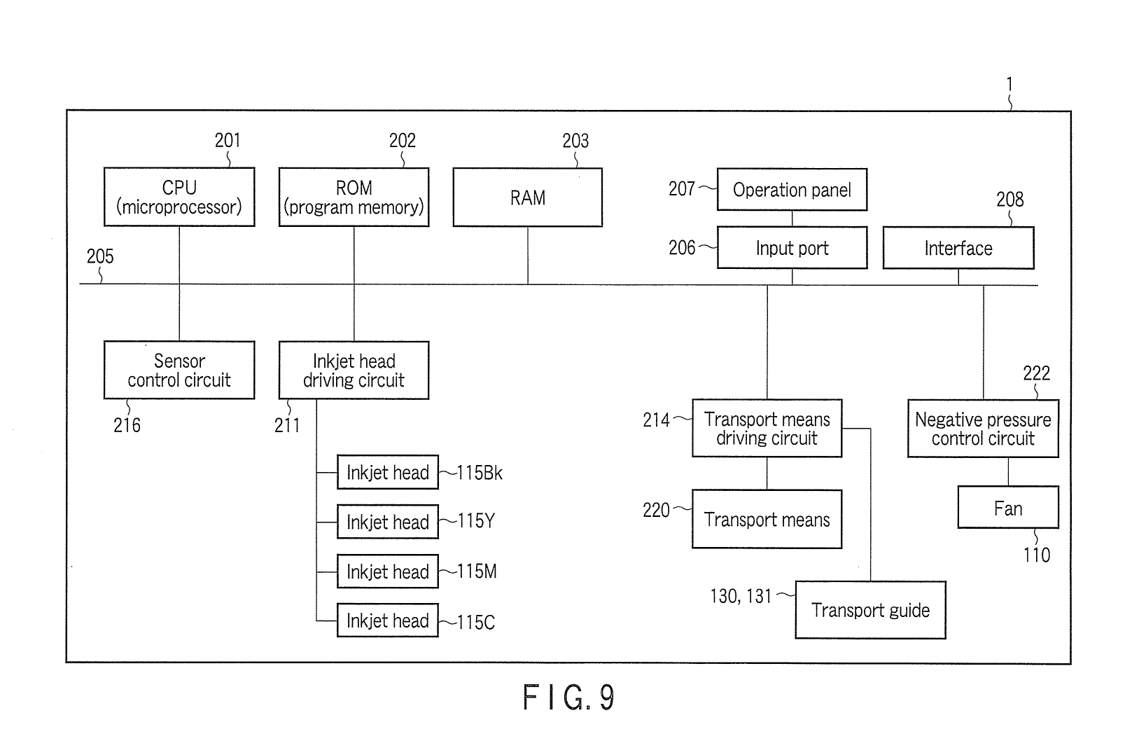

FIG. 9 is an exemplary block diagram illustrating a configuration of a control system of the inkjet image forming apparatus 1 according to the second embodiment.

The second embodiment is different from the first embodiment in that the inkjet heads and the fan are installed respectively as one set, the transport guides 130 and 131 are installed, four inkjet heads are provided, and one fan is provided.

Next, a recording operation of the inkjet image forming apparatus 1 according to the second embodiment will be described. As described with reference to FIG. 6, the CPU 201 determines the adsorption force in the front surface printing as “a” (suction amount A), and determines the adsorption force in the rear surface printing as “b” (suction amount B). Operations according to the second embodiment are the same as in ACT 01 to ACT 10 and ACT 24 according to the first embodiment. Further, the second embodiment is different from ACT 15 to ACT 23 according to the first embodiment, as follows. That is, the lower image forming section in ACT 16 to ACT 18 according to the first embodiment corresponds to the first printing according to the second embodiment, and the upper image forming section therein corresponds to the second printing according to the second embodiment. The fan 111 in ACT 19 according to the first embodiment corresponds to the first printing according to the second embodiment, and the fan 311 therein corresponds to the second printing according to the second embodiment. Thus, a flowchart illustrating the second embodiment and detailed description to each operation thereof will be omitted.

In the second embodiment, the voltage applied to the fan 110 is changed in front surface printing and rear surface printing. The suction amount is controlled in at least two ways. For example, if the suction amount A is 12 V and the suction amount B is 24 V, this is achieved by controlling a driving voltage of the fan 110. Cockling or curling of the recording paper due to ink adhesion onto the front surface of the recording paper p in the first printing (front surface printing) is corrected by the attachment force to the transport belt 107.

The recording paper p in which the image is formed on the front surface and the rear surface is transported by the transport roller pairs 112, 113 and 114, and is discharged to the paper discharge tray 117 by the paper discharge roller pair 126. At this time, the transport guide 130 is positioned in a predetermined direction so that the recording paper p transports along a predetermined route.

The above-described inkjet image forming apparatus 1 according to the first and second embodiments is an exemplary embodiment for solving the problems, and thus, the configuration and operation in the respective embodiments are not limitative. For example, the paper transport means in the image forming is not limited to the endless band-shaped belt type, and may be a cylindrical drum type (for example, U.S. Pat. No. 6,092,894).

The adsorption force (suction amount B) between the transport means and the recording paper in the rear surface printing is set to be stronger than the adsorption force (suction amount A) between the transport means and the recording paper in front surface printing, to such a degree that cockling or curling of the recording paper due to ink adhesion to the front surface of the recording paper can be remedied. Thus, it is possible to suppress image blurring due to image position misalignment or landing position misalignment which may be generated by change in the distance between the inkjet heads and the recording paper, and to suppress image quality deterioration of the rear surface printing image in double-sided printing.

Further, since the adsorption is performed using the fan, for example, differently from the electrostatic adsorption type which is a different adsorption method, it is possible to allow the recording medium to be stably adsorbed onto the transport means while being less affected by a recording medium condition or environmental conditions. Further, since the adsorption force can be easily controlled by controlling the output of the fan, it is possible to stably suppress image blurring due to image position misalignment or landing position misalignment occurring due to the distance change between the inkjet recording heads and the recording paper, and to suppress image quality deterioration of the rear surface printing image in double-sided printing.

If front surface printing and rear surface printing are set to have the same suction amount without changing the suction force of the fan (suction amount A=suction amount B), the suction force in front surface printing becomes strong. Thus, when only front surface printing or one-sided surface printing is performed, an excessive operation current is required for the fan in order to obtain an excessive adsorption force unnecessarily. Thus, power consumption is increased.

The above-described image forming section includes multi color inkjet heads, but may include single color inkjet heads. Further, the suction amount of the fan to be controlled is not limited to two values, and may be three or more values.

The respective functions described as above may be configured using hardware, or may be realized by reading programs having the respective functions using software in the computer. Further, the respective functions may be configured by appropriately selecting any one of the software and hardware.

Further, the respective functions may be realized by reading programs stored in a recording medium (not shown) in the computer. Here, as long as the recording medium in the present embodiment can record the program and is a computer readable recording medium, the recording medium may have any recording type.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet image forming apparatus comprising:
inkjet heads configured to eject aqueous ink to form an image on a front surface and a rear surface of a recording medium;
a transport section configured to adsorb the recording medium by suction to transport the recording medium under the inkjet heads; and
a controller configured to perform control in a manner that an adsorption force to the recording medium if the image is formed on a second surface of the recording medium is larger than an adsorption force to the recording medium if the image is formed on a first surface of the recording medium.

2. The apparatus according to claim 1,
further comprising a fan configured to draw in the recording medium through the transport section, wherein the recording medium is adsorbed by air suction.

3. The apparatus according to claim 1,
wherein a surface of the transport section onto which the recording medium is adsorbed is an endless band-shaped belt formed with a plurality of small through holes.

4. The apparatus according to claim 2,
wherein the controller changes the rotational rate of the fan to change the adsorption force.

5. The apparatus according to claim 2,
further comprising a recording medium reversing section configured to reverse the front and rear surfaces of the recording medium.

6. The apparatus according to claim 5,
wherein the controller performs printing on the first surface and the second surface using the same inkjet heads.

7. The apparatus according to claim 5,
wherein the inkjet heads include a first inkjet head unit and a second inkjet head unit.

8. The apparatus according to claim 7,
wherein the controller performs printing on the first surface and the second surface using the different inkjet head units.

9. The apparatus according to claim 1,
wherein the adsorption force if the image is formed on the first surface of the recording medium is determined on the basis of at least the thickness of the recording medium, and
wherein the adsorption force if the image is formed on the second surface of the recording medium is determined on the basis of at least the thickness of the recording medium and the printing rate of the first surface.

10. The apparatus according to claim 9,
wherein a surface of the transport section onto which the recording medium is adsorbed is an endless band-shaped belt formed with a plurality of small through holes.

11. The apparatus according to claim 10,
further comprising a fan configured to draw in the recording medium through the transport section.

12. The apparatus according to claim 1,
wherein the controller determines the adsorption force for printing on the second surface before printing on the first surface starts, in double-sided printing.

13. The apparatus according to claim 1,
wherein the controller controls the adsorption by static electricity.

14. An image forming method in an inkjet image forming apparatus, comprising:
adsorbing a recording medium by suction and transporting the recording medium under inkjet heads by a transport section;
forming an image on a first surface of the recording medium by ejecting aqueous ink with the inkjet heads, and
adsorbing the recording medium if an image is formed on a second surface of the recording medium after the image is formed on the first surface thereof with an larger adsorption force to the recording medium than an adsorption force to the recording medium if the image is formed on the first surface.

15. The method according to claim 14,
wherein the adsorption force if the image is formed on the first surface of the recording medium is determined on the basis of at least the thickness of the recording medium, and
wherein the adsorption force if the image is formed on the second surface of the recording medium is determined on the basis of at least the thickness of the recording medium and the printing rate of the first surface.

16. The method according to claim 14,
wherein the recording medium is reversed after the image is formed on the first surface, and the image is formed on the second surface after the recording medium is reversed.

17. The method according to claim 16,
wherein the image is formed on the first surface and the second surface by the same inkjet heads.

18. The method according to claim 14,
wherein the adsorption is performed by air suction.
